(19) United States
(12) Patent Application Publication
(10) Pub. No.: US 2021/0371244 A1
(43) Pub. Date: Dec. 2, 2021

(54) DEVICES FOR ACTIVATING ELEVATOR SAFETY BRAKES

(71) Applicant: thyssenkrupp Elevator Innovation and Operations AG, Essen (DE)

(72) Inventor: Jordan Strother, Marrietta, GA (US)

(73) Assignee: thyssenkrupp Elevator Innovation and Operations AG, Essen (DE)

(21) Appl. No.: 16/882,924

(22) Filed: May 26, 2020

(51) Int. Cl. B66B 5/18; B66B 5/00; B66B 5/04

(52) U.S. Cl. CPC B66B 5/18; B66B 7/02; B66B 5/042; B66B 5/0031

(57) ABSTRACT

Elevator systems utilize safety mechanisms with brakes that engage guide rails when an elevator car limit speed is exceeded or when a free-fall condition is detected. A device may be employed in such elevator systems to simultaneously activate the safety mechanisms and vastly decrease the likelihood that failure of the members connecting one safety mechanism will render other safety mechanisms inoperative. The device may generally include a rotatable central member that is configured to be coupled to a governor assembly of an elevator system. The device may also generally include linkages that connect the central member in parallel to the safety mechanisms. When the governor assembly is activated and exerts an activation force at the central member, the central member rotates to simultaneously activate the safety mechanisms and engage brakes of the safety mechanisms with the guide rails.

### FIELD OF THE DISCLOSURE

The present disclosure relates generally to elevator systems, including elevator safety brakes and devices for activating such elevator safety brakes.

### BACKGROUND

Many elevator systems utilize safety mechanisms installed on an elevator car to bring the elevator car to rest under certain conditions, such as an uncontrolled descent of the elevator car, for example. The safety mechanisms are actuated by a governor that is configured to trip at predetermined car speeds during upward or downward travel. When the governor activates in an elevator system with four safety mechanisms, for instance, a rope coupling the governor to a first safety mechanism and to a second safety mechanism beneath the first safety mechanism is immobilized. Immobilizing the rope exerts an activation force on the first and second safety mechanisms. The first safety mechanism is coupled by a linkage underneath the elevator car to a third safety mechanism on an opposite side of the elevator car. Activating the first safety mechanism causes the linkage to move towards, push, and ultimately activate the third safety mechanism. Thereafter, another linkage extending from the third safety mechanism may push or pull on a fourth safety mechanism located beneath the third safety mechanism, thereby activating the fourth safety mechanism. In short, activating the governor causes a chain reaction of the safety mechanisms.

But numerous problems exist with arrangements like this. For example, if the linkage between the first and third safety mechanism fails after the first safety mechanism is activated, both the third and fourth safety mechanisms are rendered inoperative due to the serial-like connection of the safety mechanisms. Systems that employ six, eight, or more safety mechanisms have even more to lose. As another example, the safety mechanisms of such traditional systems are not individually adjustable. Likewise, manufacturing tolerances compound in serially connected safety mechanisms, which increases the likelihood that the safety mechanisms will not activate simultaneously. Still further, many of these conventional systems employ heavier-than-necessary safety mechanisms because each safety mechanism must transfer and thus withstand the activation forces of all other safety mechanisms that follow. In the example above with four safety mechanisms, the first safety mechanism must transfer and thus withstand the forces necessary to activate the first, the third, and the fourth safety mechanisms. Depending on how the first and second safety mechanisms are coupled, the first safety mechanism may also need to transfer and thus withstand the force necessary to activate the second safety mechanism.

### SUMMARY

In some examples, an elevator system may include an elevator car that travels along guide rails in a shaft. A governor rope of a governor assembly may be attached directly or indirectly to the elevator car and may rotate a governor sheave as the governor rope moves with the elevator car. The governor sheave may be activated and prevent further movement of the governor rope when a limit speed of the elevator car is exceeded or when a free-fall condition of the elevator car is detected. When the governor sheave is activated, safety mechanisms that are attached to the elevator car are activated and bring the elevator car to rest. Each safety mechanism may include brakes that engage the guide rails only upon activation.

The example elevator system may include a device for simultaneously activating some, if not all, of the safety mechanisms. In some cases, the device may generally include a central member disposed beneath the elevator car. Separate linkages may couple the central member in parallel to the safety mechanisms. The linkages may be rigid in some examples. When the governor assembly is activated, the governor assembly may apply an activation force either directly at the central member via a governor arm that is disposed on and rotatably fixed to the central member, or indirectly via one of the safety mechanisms to the central member. Either way, the governor sheave and the governor rope impart an activation force that causes rotation of the central member. To reduce the activation force required to overcome inertia, friction, and the like in the system and activate the safety mechanisms, a torsional spring may preload the central member for rotation long before the activation force is ever transmitted. Notwithstanding, due to the way in which the safety mechanisms are coupled to the central member, rotation of the central member causes simultaneous activation of the safety mechanisms. Rotation of the central member may, in particular, place the linkages between the central member and the safety mechanisms in tension and thereby cause rotation of shafts of the safety mechanisms. Those shafts may pivot brakes of each safety mechanism into engagement with the guide rails.

The central member is configured to activate each safety mechanism independent of the integrity of the connections between the central member and the other safety mechanisms. For example, if a linkage between the central member and a third safety mechanism fails, the utility of a fourth safety mechanism will not be compromised, and the central member will transmit at least a portion of the activation force to the fourth safety mechanism. One reason for this is that some of all of the safety mechanisms are coupled only indirectly via the central member to each other and to the governor assembly.

In some cases, the central member may be coupled to each safety mechanism with a linkage, a pair of levers, and a pair of coupling members. For instance, a first lever may be rotatably fixed to a shaft of a first safety mechanism. The first lever may be adjustably coupled to a first end of a first linkage by a coupling member that is pivotably attached to the first lever at a location that is spaced apart from the shaft of the first safety mechanism. A second end of the first linkage may likewise be adjustably coupled to a coupling member, which in turn is pivotably connected to a lever that is disposed on and rotatably fixed to the central member.

### BRIEF DESCRIPTION OF THE DRAWINGS

FIG. 1 is a schematic view of an elevator system that includes an example device for activating multiple safety mechanisms.

FIG. 2A is a front perspective view of an example subassembly of a safety mechanism.

FIG. 2B is a rear perspective view of the example subassembly shown in FIG. 2A.

FIG. 3A is a perspective view of an example braking assembly, which is shown in an inactive state, for use with the subassembly of FIGS. 2A and 2B.

FIG. 3B is a perspective view of the example braking assembly of FIG. 3A in an active state.

FIG. 4 is a perspective view of an example device for activating multiple safety mechanisms.

FIG. 5 is a front view of the example device in FIG. 4.

FIG. 6 is a schematic view of an elevator system that includes another example device for activating multiple safety mechanisms.

### DETAILED DESCRIPTION

Although certain example methods and apparatuses are described herein, the scope of coverage of this patent is not limited thereto. On the contrary, this patent covers all methods, apparatuses, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claim need not necessarily be performed in the order in which they are recited, unless so required by the context of the claims. In addition, all references to one skilled in the art shall be understood to refer to one having ordinary skill in the art. Finally, many descriptors such as “first,” “second,” “third,” and so on herein aid the description of the drawings, but do not necessarily correspond to like descriptors in the claims.

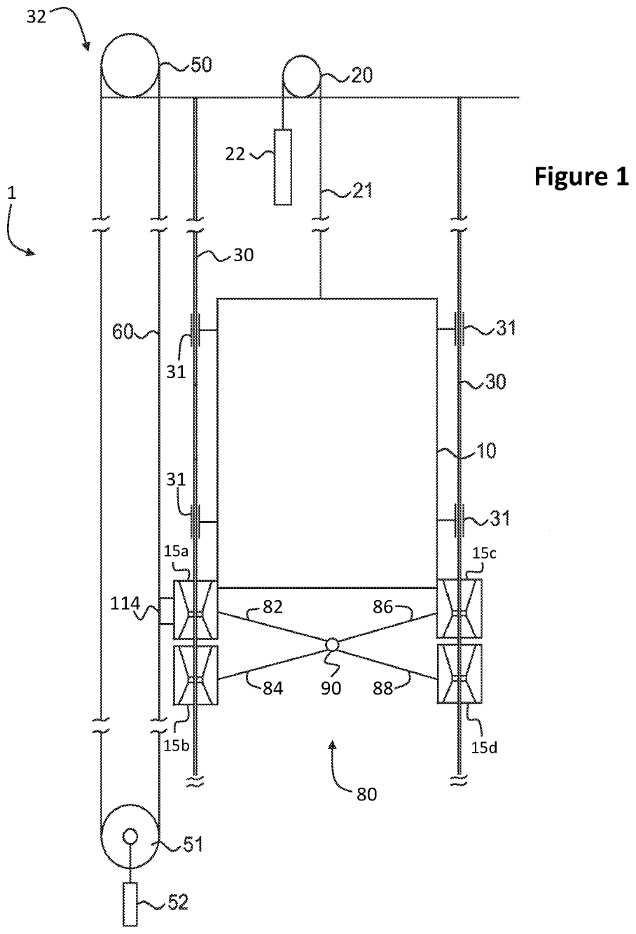

With reference to FIG. 1, an example elevator system 1 may include an elevator car 10 that moves between floors in an elevator shaft by way of, for example, a motor 20 acting on one or more traction cables 21. One end of the traction cable 21 may be connected to the elevator car 10, while an opposite end of the traction cable 21 may be connected to a counterweight 22. The elevator car 10 may travel along a pair of guide rails 30 extending vertically in the elevator shaft. The elevator car 10 may engage the guide rails 30 via guides 31.

The elevator system 1 may further include a governor assembly 32 having a governor sheave 50 that is mounted in a top portion of the elevator shaft and a governor rope 60 wound between the governor sheave 50 and a tail sheave 51. The governor rope 60 may be tensioned by a tension weight 52 acting on the tail sheave 51. Alternatively, the governor rope 60 may be secured to a tail sheave secured in a pit of the elevator shaft. Nonetheless, the governor rope 60 may be attached to the elevator car 10 in many ways. In some examples, for instance, the governor rope 60 may be attached to the elevator car 10 via a governor arm. In other examples, such as the example shown in FIG. 1, the governor rope 60 may be attached to the elevator car 10 via a safety activating lever 114. The safety activating lever 114 may be coupled to a first safety mechanism 15a that is mounted on the elevator car 10. The safety activating lever 114 may in some cases be considered part of the first safety mechanism 15a. In normal operation, such as when the speed of the elevator car 10 is less than a limit speed, the elevator car 10 drives the governor rope 60. Such movement of the governor rope 60 rotates the governor sheave 50. During normal operation, any stress on the safety activating lever 114 caused by a pulling force due to the inertia of the governor rope 60 may be offset by, for example, one or more holding tension springs.

When the speed of the elevator car 10 reaches or exceeds a limit speed, such as when the elevator car 10 starts to free fall, the governor sheave 50 locks. One way the governor sheave 50 may lock is by actuation of centrifugal weights that engage a toothed fixed cylinder. In some examples, the governor sheave 50 may sense a free fall state—and hence a need to lock—before the limit speed is even reached. Notwithstanding, the governor rope 60 is immobilized. This causes a pulling force on the safety activating lever 114, which amounts to an upward pulling force when the elevator car 10 exceeds a downward limit speed and which amounts to a downward pulling force when the elevator car 10 exceeds an upward limit speed. The safety activating lever 114 may be torqued in a way that actuates brakes such as safety wedges of the first safety mechanism 15a. Upon activation, the brakes engage the guide rails 30 by clamping the guide rails 30 to help bring the elevator car 10 to a safe stop. A second safety mechanism 15b, a third safety mechanism 15c, and a fourth safety mechanism 15d may also be activated by way of an example device 80 to engage the guide rails 30 and help bring the elevator car 10 to a safe stop. As explained in more detail below, the device 80 is configured to activate numerous or even all safety mechanisms in parallel, as opposed to serially. For now, as shown purely schematically in FIG. 1, it should be understood that the device 80 may generally comprise a first linkage 82, a second linkage 84, a third linkage 86, and a fourth linkage 88 connecting the respective safety mechanisms 15a, 15b, 15c, 15d to a central member 90. Some example central members may be axles that are straight or substantially straight. Additionally or alternatively, some example central members may be segmented, multifaceted, and/or even disjointed like a crankshaft.

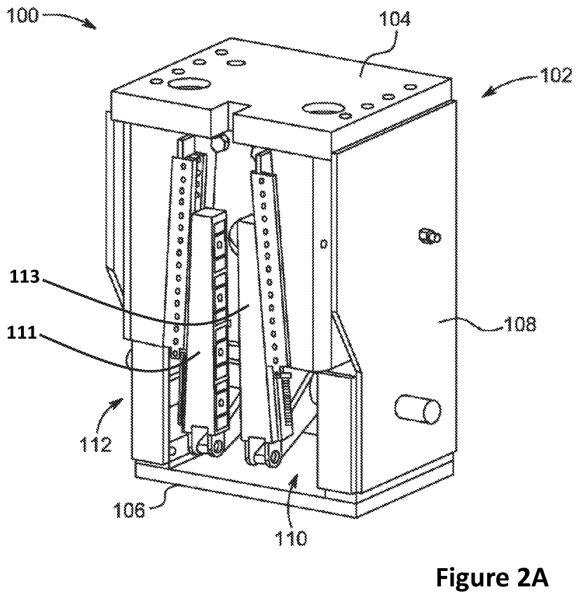

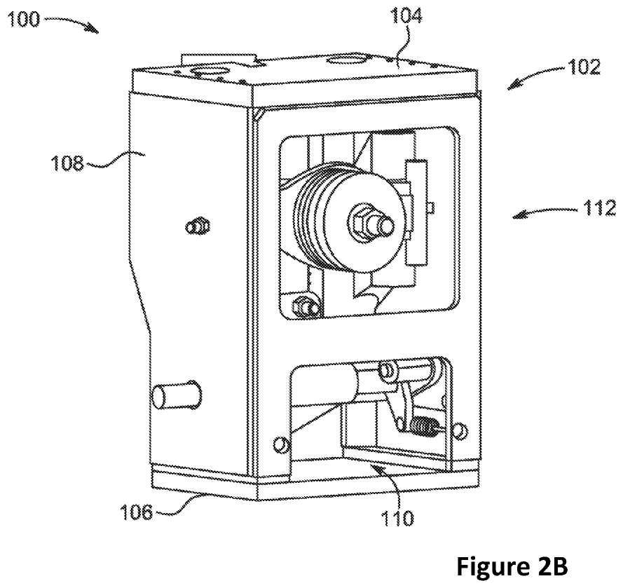

Each safety mechanism 15a, 15b, 15c, 15d in FIG. 1 is shown schematically to include pairs of brakes in the form of safety wedges for responding to excessive speeds during downward travel and upward travel. To simplify and for purposes of explanation, however, FIGS. 2A and 2B depict an example subassembly 100 of one or more of the safety mechanisms 15a, 15b, 15c, 15d shown schematically in FIG. 1. It goes without saying that in some examples the present disclosure may employ safety mechanisms that safeguard against excessive speeds in both upward and downward directions, whereas in other examples the present disclosure may employ safety mechanisms that safeguard against excessive speeds only in the downward direction. Still further, it should be understood that the present disclosure may be equally applicable to safety mechanisms that safeguard against excessive speeds that can occur in elevator systems or other transportation systems that involve horizontal travel as opposed, or in addition, to vertical travel.

The example subassembly 100 of FIGS. 2A and 2B may be fixed, such as by fastening, welding, or other mechanical connection means, to at least a portion of the elevator car 10 such as a safety plank, a car sling, the guides 31, or the like. In some examples, one or more safety mechanisms may also be secured to the counterweight 22. The example subassembly 100 generally includes a housing 102 with a top member 104 separated from a bottom member 106 by a pair of side members 108. At least a portion of the housing 102 is configured for attachment, either directly or indirectly, to the elevator car 10. The housing 102 defines a cavity 110 for a braking assembly 112 that is acted upon, directly or indirectly, by the governor rope 60. The braking assembly 112 is operable between an inactive state where brakes 111, 113 of the braking assembly 112 are disengaged from the guide rail 30, and an active state where at least a portion of the brakes 111, 113 of the braking assembly 112 are directly engaged with the guide rail 30. In this example, the brakes 111, 113 are configured as safety wedges, also known as “safeties.”

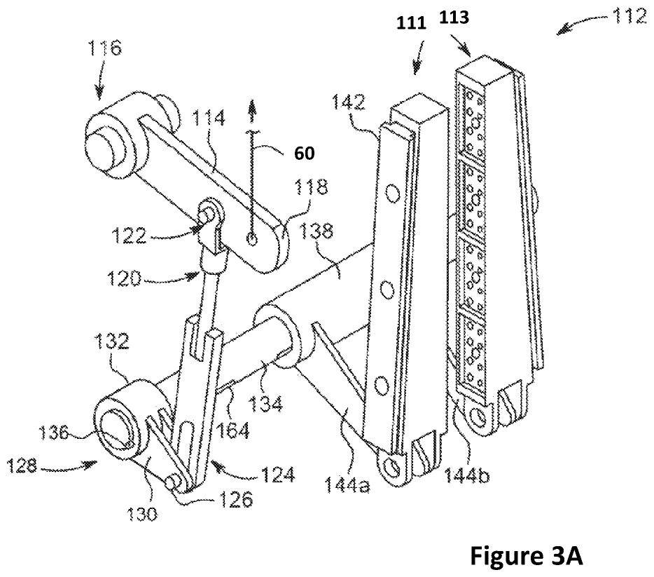

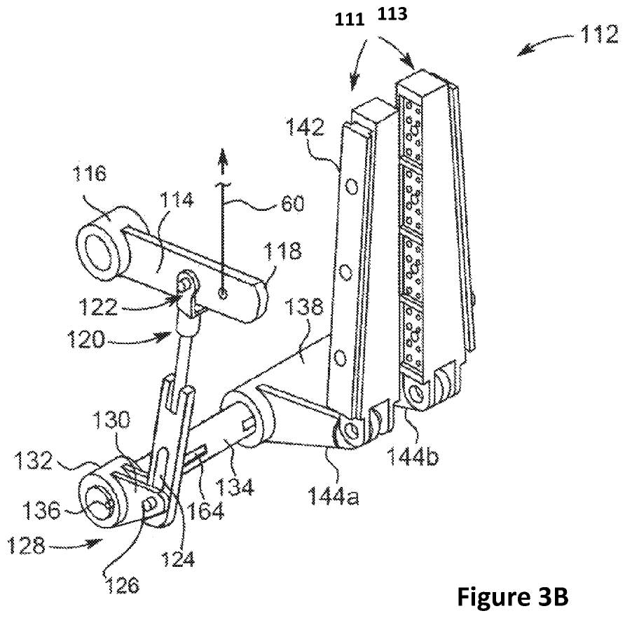

With reference to FIGS. 3A and 3B, the example braking assembly 112 is shown removed from the housing 102. FIG. 3A illustrates the braking assembly 112 in an inactive state, whereas FIG. 3B illustrates the braking assembly 112 in an active state. The safety activating lever 114 of the braking assembly 112 may include a first end 116 pivotally connected to the housing 102 and a second end 118 connected to at least a portion of the governor assembly 32, such as the governor rope 60. A clevis rod 120 may be connected to the safety activating lever 114 between the first end 116 and the second end 118. In some examples, the clevis rod 120 may be connected to the safety activating lever 114 by a pinned connection 122 or other mechanical connection means. The clevis rod 120 may have a slotted end 124 opposite the pinned connection 122. The slotted end 124 receives a pin 126 of a governor arm 128 such that the pin 126 is movable within the slotted end 124 of the clevis rod 120 with movement of the clevis rod 120 when the governor rope 60 acts on the safety activating lever 114 in the direction of the arrows in FIGS. 3A and 3B. The governor arm 128 may have arms 130 connected to a central portion 132 that is keyed to a rotatable shaft 134 by a key 136. In this manner, rotation of the governor arm 128 due to movement of the clevis rod 120 causes a corresponding rotation of the shaft 134. A brake carrier 138 is offset axially from the governor arm 128 along a longitudinal axis of the shaft 134. The brake carrier 138 is also keyed to the shaft 134 such that a rotation of the shaft 134 causes a corresponding rotation of the brake carrier 138. The brakes 111, 113 may be attached to the brake carrier 138 by arms 144a, 144b. Rotation of the shaft 134 due to movement of the governor arm 128 causes the brake carrier 138 to rotate, thereby moving the brakes 111, 113 from a first, inactive position shown in FIG. 3A to a second, active position shown in FIG. 3B where the brakes 111, 113 engage the guide rail 30 to stop the elevator car 10. In some examples, the subassembly 100 and/or the safety mechanisms 15a, 15b, 15c, 15d may include additional and/or alternative features as disclosed in U.S. Pat. No. 9,873,592, which is entitled “Governor Inertia Carrier for Elevator Safety Mechanism” and is hereby incorporated by reference in its entirety.

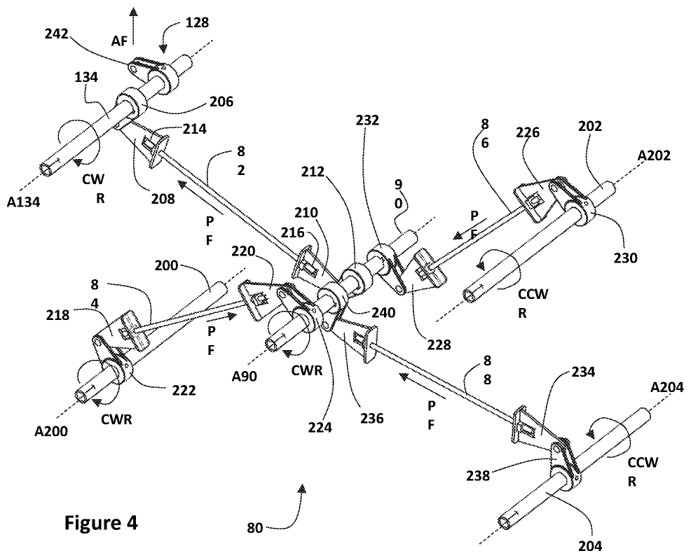

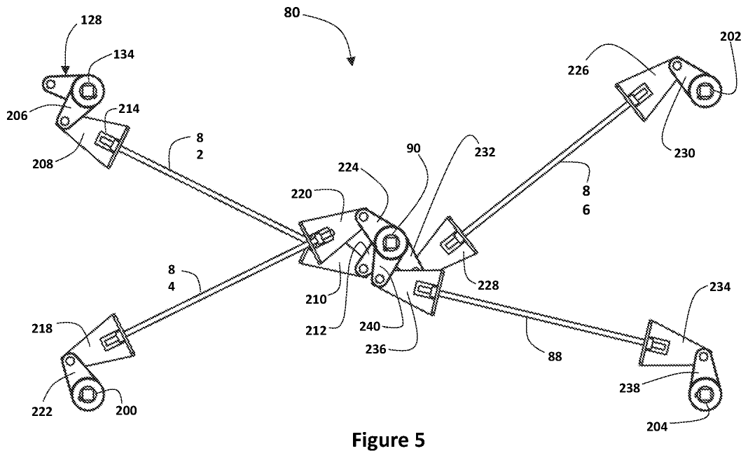

With reference now to FIGS. 4 and 5, one example device 80 for simultaneously activating multiple safety mechanisms is shown. For the sake of clarity, the safety mechanisms 15a, 15b, 15c, 15d are generally not shown, other than the shaft 134 of the first safety mechanism 15a, a shaft 200 of the second safety mechanism 15b, a shaft 202 of the third safety mechanism 15c, and a shaft 204 of the fourth safety mechanism 15d. The shaft 134 of the first safety mechanism 15a may be rotatably fixed to a lever 206 that is coupled to the linkage 82 by way of a coupling member 208. The lever 206 and the coupling member 208 may be rotatably attached to one another at a point that is spaced apart from a rotational axis A134 about which the shaft 134 rotates. In some cases, the lever 206 may be coupled directly to the linkage 82. The linkage 82 may be coupled by way of a coupling member 210 to a lever 212 that is rotatably fixed to the central member 90. The lever 212 and the coupling member 210 may likewise be rotatably attached to one another at a point that is spaced apart from a rotational axis A90 about which the central member 90 rotates. One example way to enable individual adjustment of the shaft 134 and hence the first safety mechanism 15a is by threadedly engaging the linkage 82 with one or both of the coupling members 208, 210. Locking nuts and/or other fasteners disposed in openings 214, 216 of the coupling members 208, 210 may adjustably receive and secure threaded ends of the linkage 82.

In similar fashion, the shaft 200 of the second safety mechanism 15b may be coupled to the central member 90 by way of coupling members 218, 220 and levers 222, 224. The shaft 202 of the third safety mechanism 15c may be coupled to the central member 90 by way of coupling members 226, 228 and levers 230, 232 too. And the shaft 204 of the fourth safety mechanism 15d may be coupled to the central member 90 by way of coupling members 234, 236 and levers 238, 240. Much like the first safety mechanism 15a, the second, third, and fourth safety mechanisms 15b, 15c, 15d may also be adjustable by way of, for example, adjustable connections at one or both ends of the respective linkages 84, 86, 88.

With respect to the operation of this particular example device 80, as shown best in FIG. 4, when the governor sheave 50 locks due to free fall of the elevator car 10 or a limit speed of the elevator car 10 being exceeded, an activation force AF is applied by way of the clevis rod 120 and/or the governor rope 60, for example, to a distal end 242 of the governor arm 128 that is spaced apart from the rotational axis of the shaft 134. Consequently, the shaft 134 of the first safety mechanism 15a experiences clockwise rotation CWR about the rotational axis 134. Because the lever 206 is rotatably fixed to the shaft 134, the lever 206 rotates clockwise as well and causes the coupling member 208 to impart a pulling force PF on the linkage 82 and the coupling member 210. The pulling force PF in turn causes the lever 212 and hence the central member 90 to experience clockwise rotation CWR about the rotational axis A90 of the central member 90.

The clockwise rotation CWR of the central member 90 causes simultaneous rotation of the shafts 200, 202, 204 of, respectively, the second, third, and fourth safety mechanisms 15b, 15c, 15d by way of the levers 222, 224, 230, 232, 238, 240; the coupling members 218, 220, 226, 228, 234, 236; and the linkages 84, 86, 88. In particular, the shaft 200 of the second safety mechanism 15b experiences clockwise rotation CWR about a rotational axis A200 to activate the second safety mechanism 15b. The shaft 202 of the third safety mechanism 15c experiences counterclockwise rotation CCWR about a rotational axis A202 to activate the third safety mechanism 15c. And the shaft 204 of the fourth safety mechanism 15d experiences counterclockwise rotation CCWR about a rotational axis A204 to activate the fourth safety mechanism 15d.

In other words, as the shaft 134 rotates to activate the first safety mechanism 15a, the central member 90 rotates. As the central member 90 rotates, the shafts 200, 202, 204 rotate to activate, respectively, the second, third, and fourth safety mechanisms 15b, 15c, 15d. Thus the central member 90 activates at least the second, third, and fourth safety mechanisms 15b, 15c, 15d in parallel. Moreover, the central member 90 is configured to activate the second safety mechanism 15b independent of the integrity of the connections between the central member 90 and the third and fourth safety mechanisms 15c, 15d. Likewise, the central member 90 is configured to activate the third safety mechanism 15c independent of the integrity of the connections between the central member 90 and the second and fourth safety mechanisms 15b, 15d. The same goes for the fourth safety mechanism 15d: the central member 90 is configured to activate the fourth safety mechanism 15d independent of the integrity of the connections between the central member 90 and the second and third safety mechanisms 15b, 15c.

When the activation force AF is applied to the device 80 shown in FIGS. 4 and 5, all of the linkages 82, 84, 86, 88 are placed in tension, rather than compression, for force transfers to and from the central member 90. In examples such as these, those having ordinary skill in the art will recognize that the linkages may be configured as flexible linkages (e.g., steel cable), rigid linkages (e.g., a bar that can hold its own shape), and/or combinations thereof. In other examples, however, all or some of the linkages may be placed in compression. That said, it may be desirable to configure as many of the linkages as possible, if not all, to be placed in tension because tension-loaded linkages are less likely to fail and offer better (e.g., more efficient) force transfer properties.

Further yet, those having ordinary skill in the art should understand that the present disclosure is in no way limited to elevator systems that employ four safety mechanisms. Any number of safety mechanisms may be coupled to a rotatable central member. Similarly, the present disclosure provides a flexible solution in that placement of the central member can vary from one application to the next, and the lengths of the linkages may likewise vary to accommodate the number and placement of the safety mechanisms and/or the placement of the central member. In the same vein, it should be understood how the present disclosure may be applicable to Type A, Type B, and Type C safeties and governor assemblies with more than one governor rope.

With respect to the example device 80 in FIGS. 4 and 5, the activation force AF applied to the governor arm 128 to activate the safety mechanisms 15a, 15b, 15c, 15d must be great enough to overcome friction and inertia inherent in the device 80, its constituent components, and the safety mechanisms 15a, 15b, 15c, 15d. To reduce the magnitude of the activation force AF that is necessary, particularly in elevator systems that utilize rigid linkages and a considerable number of safety mechanisms, a spring (e.g., a torsional spring) may be employed to preload (e.g., pre-torque) the central member 90—making it easier to activate the respective safety mechanisms.

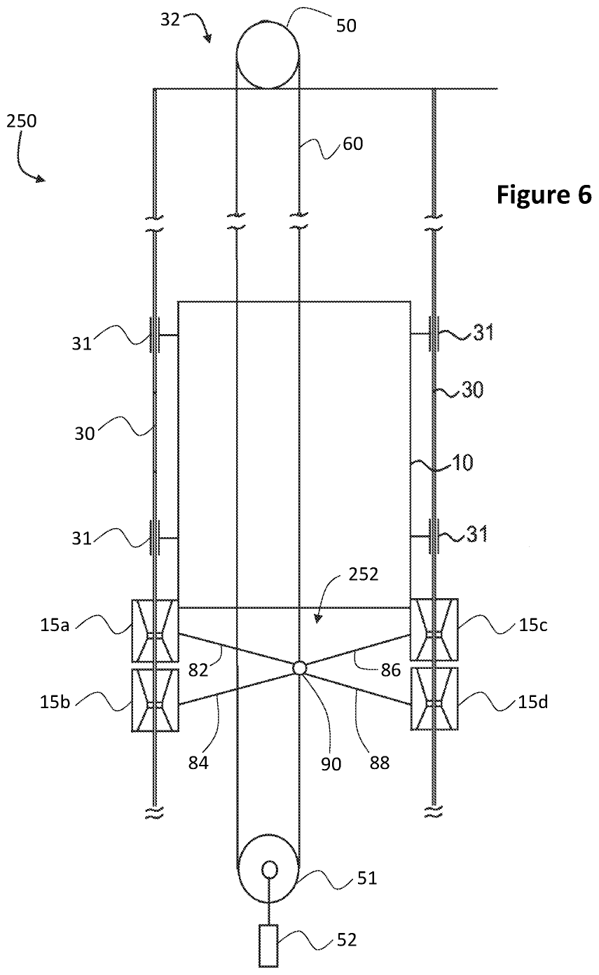

The activation force AF applied with respect to the example device 80 is routed through the shaft 134 of the first safety mechanism 15a. In other examples, though, the governor assembly 32 may apply the force required to activate the safety mechanisms 15a, 15b, 15c, 15d directly to the central member 90. For instance, FIG. 6 shows schematically an example elevator system 250 wherein the governor assembly 32 is coupled to the central member 90 of an example device 252 for simultaneously activating safety mechanisms. In this example, the governor assembly 32 applies a force or a torque to the central member 90 first. One purely exemplary way of applying such a force or torque would be to secure the governor rope 60 to a distal end of a governor arm disposed on and rotatably fixed to the central member 90. Alternatively, some portion of the governor assembly 32 could be connected to one of the levers 212, 224, 232, 240 that are rotatably fixed to the central member 90. Notwithstanding, the central member 90 then simultaneously transfers the activation force or torque to the shafts 134, 200, 202, 204 of all the safety mechanisms 15a, 15b, 15c, 15d. For the sake of clarity, the motor, the traction cable, and the counterweight are not shown in the example elevator system 250.

In this way, not one of the safety mechanisms 15a, 15b, 15c, 15d must transfer any part of the overall activation force associated with any other safety mechanism 15a, 15b, 15c, 15d. Likewise, none of the safety mechanisms 15a, 15b, 15c, 15d is at risk of being rendered inoperative if the respective linkage between the central member 90 and a different safety mechanism 15a, 15b, 15c, 15d fails.

Further, some safety mechanisms experience a problem known as “chatter” whereby the brakes of the safety mechanism do not stay firmly engaged with the guide rails. In other words, the braking force applied by the safety mechanism is not particularly smooth. To address this issue, some example devices for simultaneously activating safety mechanisms may include one or more ratchets. A ratchet may be disposed at or on a central member so that once the central member rotates to activate the safety mechanisms, the ratchet prevents the central member from rotating in a way that permits the brakes of the respective safety mechanisms to intermittently disengage from the guide rails.

What is claimed is:

1. An elevator system comprising:
guide rails;
an elevator car that travels along the guide rails;
a governor assembly comprising a governor rope;
safety mechanisms attached to the elevator car; and
a device for activating the safety mechanisms, the device comprising:
a central member disposed beneath the elevator car, and
linkages that couple the safety mechanisms in parallel to the central member, wherein the central member, the linkages, and the safety mechanisms are configured such that rotation of the central member causes simultaneous activation of the safety mechanisms.

2. The elevator system of claim 1 wherein the central member is coupled to the governor rope, wherein an activation force applied by the governor rope at the central member causes rotation of the central member, wherein the safety mechanisms and the governor assembly are coupled only via the central member.

3. The elevator system of claim 1 wherein the central member is configured to activate a first safety mechanism independent of the integrity of a connection between the central member and a second safety mechanism, wherein the central member is configured to activate the second safety mechanism independent of the integrity of a connection between the central member and the first safety mechanism.

4. The elevator system of claim 1 wherein the safety mechanisms are coupled to one another only indirectly via the central member.

5. The elevator system of claim 1 wherein a shaft of a first safety mechanism is coupled to the governor rope and transfers an activation force applied by the governor rope to the central member, wherein rotation of the central member causes simultaneous activation of a second safety mechanism and a third safety mechanism by rotating shafts of the second and third safety mechanisms.

6. The elevator system of claim 1 wherein rotation of the central member causes shafts of the safety mechanisms to rotate, wherein rotation of the shafts of the safety mechanisms causes brakes of the safety mechanisms to engage the guide rails.

7. The elevator system of claim 6 wherein rotation of the central member places the linkages coupling the safety mechanisms and the central member in tension.

8. The elevator system of claim 1 comprising a governor arm disposed on and rotatably fixed to the central member, the governor arm being attached to the governor rope, wherein the central member is configured to transfer at least a portion of an activation force applied to the governor arm to the safety mechanisms by pulling the linkages that couple the safety mechanisms to the central member.

9. A device for activating safety mechanisms in parallel, the device comprising:
a central member configured to be coupled to a governor assembly; and
linkages configured to couple in parallel the central member to safety mechanisms such that rotation of the central member causes parallel activation of the safety mechanisms, wherein the central member is configured to activate a first of the safety mechanisms independent of the integrity of a connection between the central member and a second of the safety mechanisms, wherein the central member is configured to activate the second of the safety mechanisms independent of the integrity of a connection between the central member and the first of the safety mechanisms.

10. The device of claim 9 comprising a governor arm that is disposed on and rotatably fixed to the central member, wherein the central member is configured to be coupled to the governor assembly via the governor arm, wherein the central member is configured to couple the governor assembly and the safety mechanisms.

11. The device of claim 9 wherein the safety mechanisms are coupled to one another only indirectly via the central member.

12. The device of claim 9 comprising:
a first lever that is rotatably fixed to a shaft of the first of the safety mechanisms, wherein the first lever is coupled to a first of the linkages; and
a second lever that is rotatably fixed to the central member, wherein the second lever is coupled to the first of the linkages.

13. The device of claim 12 comprising a coupling member disposed between an end of the first of the linkages and either the first lever or the second lever, the coupling member being pivotably coupled to either the first lever or the second lever, wherein the coupling member is adjustably attached to the end of the first of the linkages.

14. The device of claim 9 wherein the linkages are configured to couple the central member to the safety mechanisms such that an activation force applied at the central member by the governor assembly causes the linkages to be placed in tension.

15. The device of claim 9 wherein parallel activation is simultaneous activation, wherein the linkages are rigid linkages.

16. A device comprising:
a central member; and
linkages configured to couple in parallel the central member to safety mechanisms such that rotation of the central member causes activation of the safety mechanisms, wherein the central member is configured to activate a first of the safety mechanisms independent of the integrity of a connection between the central member and a second of the safety mechanisms, wherein the central member is configured to activate the second of the safety mechanisms independent of the integrity of a connection between the central member and the first of the safety mechanisms.

17. The device of claim 16 wherein the central member is configured to be coupled to a third safety mechanism that is coupled to a governor assembly, wherein rotation of a shaft of the third safety mechanism due to the governor assembly is configured to cause rotation of the central member.

18. The device of claim 17 comprising a governor arm of the governor assembly and the shaft of the third safety mechanism, wherein the governor arm is disposed on and rotatably fixed to the shaft of the third safety mechanism, wherein the central member is configured to transfer at least a portion of an activation force applied to the governor arm to the first and second of the safety mechanisms by pulling the linkages that couple the first and second of the safety mechanisms to the central member.

19. The device of claim 16 comprising:
a first lever that is disposed on and rotatably fixed to the central member;
a first coupling member that is pivotably attached to the first lever at a location that is spaced apart from the central member, the first coupling member being secured to a first end of a first of the linkages;
a second coupling member that is secured to a second end of the first of the linkages; and
a second lever that is disposed on and rotatably fixed to a shaft of the first of the safety mechanisms, the second lever being pivotably attached to the second coupling member at a location that is spaced apart from the shaft of the first of the safety mechanisms.

20. The device of claim 16 comprising a torsional spring that preloads the central member for rotation.
